(19) United States
(12) Patent Application Publication
(10) Pub. No.: US 2010/0156767 A1
(43) Pub. Date: Jun. 24, 2010

(54) ELECTRONIC LED DISPLAY DEVICE FOR DISPLAYING PATTERN ON ROTATABLE OBJECT

(76) Inventor: Wan-Hsiang Huang, Taipei City (TW)

Correspondence Address: Wan-Hsiang Huang;Wan-Hsiang Huang, 235 Chung - Ho Box 8-24 Taipei, Taiwan, R. O. C., 235 Chung - Ho Box 8-24 Taipei, Taiwan, R. O. C., Taipei, 235, omitted

(21) Appl. No.: 12/339,027

(22) Filed: Dec. 18, 2008

(51) Int. Cl. G09G 3/32

(52) U.S. Cl. 345/82

(57) ABSTRACT

An electronic LED display device for displaying a pattern on a rotatable object; wherein when the rotating object rotates with a high speed, the pattern will display; the device comprises a printed circuit board on the rotatable object is arranged with a bank of light emitting diodes; a speed detection sensor for detecting speeds of the rotatable object; a memory storing with at least one pattern and algorithms for displaying; a processor being a controlling center; the processor receiving signals from the synchronous unit; wherein the processor processing a simulation calculation for displaying the light emitting diodes by using a simulated projection line to be projected to the pattern; and a current controller receiving signals from the processor; the current controller controlling on-and-off operation of each of the light emitting diodes in the printed circuit board.

### FIELD OF THE INVENTION

The present invention relates to patterns display be LEDs, and particularly to an electronic LED display device for displaying a pattern on a rotatable object, wherein a bank of light emitting diodes are arranged on a rotatable object. By the present invention, when the rotatable object rotates, by the affect of photogene, the light emitting diodes will display with a predetermined pattern which can be viewed clearly.

### BACKGROUND OF THE INVENTION

There are many prior arts about the display of LED which are mainly used for indications, decorations and advertisements. For example, in U.S. Pat. No. 7,036,959, a LED lampshade for advertisement brand and decoration is disclosed. The device comprises an LED lampshade for advertisement brand and decoration which comprises a deformable cover having two tenons at two ends; the cover being originally a flat shape; after assembly, the cover having a U shape; and a seat having two trenches positioned corresponding to the two tenons of the cover. The seat has a groove for locating an LED lamp. Two lower ends of the seat have the tenons, respectively. An upper side of each tenon has a stopper; and a transparent portion is formed on the cover. The groove is formed between the two trenches. Each trench has a corresponding elastomer aside the trench; each elastomer has a corresponding seat notch for receiving the elastomer as the elastomer is pressed downwards. In assembly, the two tenons of the cover are inserted into the trenches of the seat so that the cover is formed on the seat.

In another prior art, U.S. Pat. No. 6,910,788 A wheel light device for a vehicle with an electrical battery, in that, wheels, fenders and wheel wells that shines light onto and in front of one of each of the wheels of the vehicle. The device includes LED bulbs in a casing and a reflector that attaches to the bulbs to direct light onto the wheels of a vehicle. A waterseal canal, for draining any water and condensation that may accumulate within the wheel light device, and a waterproofing gasket, for sealing the device from any water reaching its components, protect the device from water. There are several different embodiments of the invention including an outer fender flare mounted embodiment with multiple LED bulbs, an inner fender mounted embodiment with multiple LED bulbs, provisions to address arched wheel wells or horizontally straight wheel wells, various safety light provisions in addition to additional supplemental features.

However in all prior arts, maybe the LEDs can provide the function of advertisement or display, but no prior art can provide the function for displaying a pattern on a rotating wheel with clear vision so as to have the function of advertisement. This is because the wheel is a rotating unit which will cause the image to rotate therewith so that the pattern thereon will become vague. As a result the viewer can not see the advertising patter clearly even the viewer can not see what displayed on the wheel.

### SUMMARY OF THE INVENTION

Accordingly, the object of the present invention is to provide an electronic LED display device for displaying a pattern on a rotatable object, wherein a bank of light emitting diodes are arranged on a rotatable object. By the present invention, when the rotatable object rotates, by the affect of photogene, the light emitting diodes will display a predetermined pattern which can be viewed clearly so as to achieve the object of alerting the pattern to people. The present invention is especially suitable for wheels. Rotation of the wheel will cause the pattern to be displayed with a flash affect which cannot achieve by other prior art.

The objects of the present invention are that fixed patterns can be displayed on a rotating object. The pattern to be displayed is changeable and the width of the pattern is controlled. Thus it is a wide application in advertisement. Furthermore, the user can select any pattern he (or she) likes instead of only the pattern with advertisement objective.

To achieve above object, the present invention provides An electronic LED display device for displaying a pattern on a rotatable object; wherein when the rotating object rotates with a high speed, the pattern will display; the device comprising: a printed circuit board on the rotatable object is arranged with a bank of light emitting diodes; a speed detection sensor for detecting speeds of the rotatable object; a memory storing with at least one pattern and algorithms for displaying; a processor being a controlling center; the processor receiving signals from the synchronous unit; wherein the processor processing a simulation calculation in which, a simulated projection line is projected to the pattern; the projection line is corresponding to the light emitting diodes; the projection line is formed by a plurality of points, each point represents a light emitting diode of the light emitting diodes in the printed circuit board; after projection, the points of an overlapping section of the projection line between the projection line and the pattern represents some of light emitting diodes corresponding to the point in the overlapping section will be lighted up; in the next time period, the projection line moves along a round path so as to drive the light emitting diodes to display with different pattern; and a current controller receiving signals from the processor; the current controller controlling on-and-off operation of each of the light emitting diodes in the printed circuit board.

The electronic LED display device for displaying a pattern on a rotatable object further comprises an I/O (input/device) connected to the memory for inputting patterns to the memory; a synchronous unit receives the speed signals from the speed detection sensor and determines a time period as a reference for lighting up the light emitting diodes; and the synchronous unit is used to control the time period for transferring the point sets from the processor to the current controller; and a position sensor for detecting a position of the first printed circuit board on the rotatable object.

The various objects and advantages of the present invention will be more readily understood from the following detailed description when read in conjunction with the appended drawing.

### BRIEF DESCRIPTION OF THE DRAWINGS

FIG. 1 shows the structure and element of the present invention.

FIGS. 2(A) to 2(C) are schematic view showing the operation of the present invention.

FIGS. 3(A) to 3(B) show the application of the present invention, where the present invention is applied to cars for displaying the brands of the car manufacturers.

FIGS. 4A and 4B show one application of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

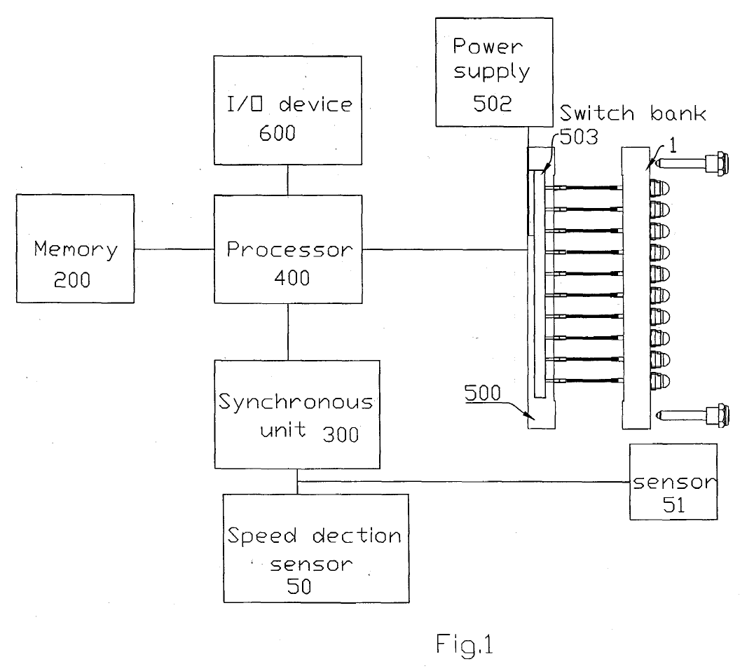

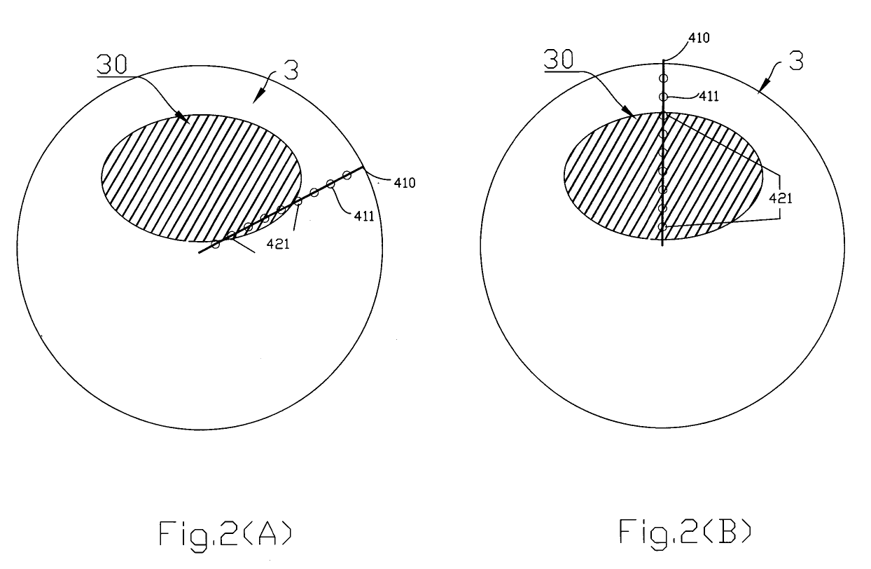

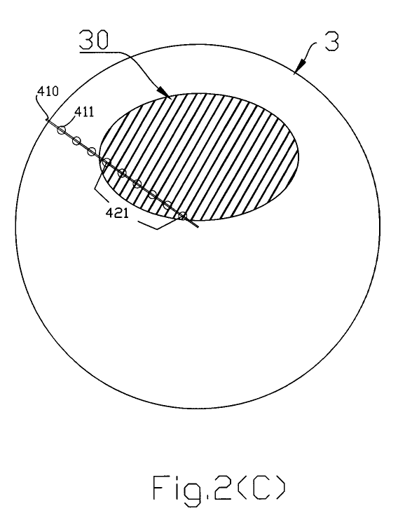

Referring to FIG. 1 and FIG. 2, the present invention relates to a pattern display device by LEDs on a rotating object. A bank of LEDs are arranged on a rotatable object 101. When the rotatable object 101 rotates with high speeds, a pattern (may be texts or figures) is displayed by the LEDs. The present invention has improved the defect in the prior art. In the prior art, the pattern on a high speed rotatable object can not be clearly identified. The structure of the present invention will be described in detail in the following.

A first printed circuit board 1 on the rotatable object is arranged with a bank of light emitting diodes 10. The first printed circuit board 1 on the rotatable object is arranged at one outer side of the rotatable object 101 which can be easily viewed by viewers.

A speed detection sensor 50 serves to detect the speed of the rotatable object 101. For example, the speed detection sensor 50 can be installed on the rotatable object 101.

A position sensor 51 for detecting a position of the first printed circuit board 1 on the rotatable object 101.

A memory 200 stores with at least one pattern 201 and algorithms of the present invention.

A processor 400 is a controlling center of the present invention. The processor 400 receives the signals from the synchronous unit 300. The processor 400 processes a simulation calculation. As referring to FIG. 2(A) to 2(C), firstly, a projection line 410 is projected to the pattern. The projection line is corresponding to the light emitting diodes 10. That is, the projection line is formed by a plurality of points 411, each point 411 represents a light emitting diode of the light emitting diodes 10 in the first printed circuit board 1. After projection, the points of an overlapping section of the projection line between the projection line and the pattern represents some of light emitting diodes 10 corresponding to the point in the overlapping section will be lighted up. These points are called as the first point set 421 which indicates the light emitting diodes in the light emitting diodes 10 corresponding to the points in the first point set 421 will light up.

In the next step, the projection line through an angle along a round area so as to derive another set of light emitting diodes 10 which need to be lighted up in the second time. These points are called as second point set 422. The process is repeated until the projection line move through the whole angle with one center point extending from one end of projection line being fixed at the center of the round. Thus, in the process, many different points sets are derived, which are sequentially called as first point set 421, second point set 422, third point set 423, etc.

A synchronous unit 300 receives the speed signals from the speed detection sensor 50 and determines a time period as a reference for lighting up the light emitting diodes 10.

A current controller 500 receives signals from the processor 400. The current controller 500 controls on-and-off operation of each of the light emitting diodes 10 in the first printed circuit board 1. Each light emitting diode 10 is connected to the current controller 500 through a conduction wire 501. The current controller 500 is connected to a power supply 502. All the conduction wires 501 from the light emitting diodes 10 are connected in parallel to the power supply 502 through the switch bank 503. The current controller 500 controls the on and off of each of the light emitting diodes 10 through the switch bank 503.

The present invention further includes an I/O (input/device) 600 which is connected to the memory for inputting patterns to the memory 200 to the rotatable object can display various pattern to the memory for displaying by a rotating object. Thus the user can read a pattern from a computer or other storage device. If the user needs to display a pattern he (or she) like, the user can scan the pattern to a computer and then the pattern is input to the processor 400 for displaying by the rotating object.

In operation, the processor 400 firstly transfers the first point set 421 to the current controller 500. Then the current controller 500 will cause that that light emitting diodes in the light emitting diodes 10 corresponding to the first point set to light. Secondly, after a time period which is determined in the synchronous unit 300, the processor 400 transfers the second point set 422 to the current controller 500. Then the current controller 500 will cause that that light emitting diodes in the light emitting diodes 10 corresponding to the second point set to light. The process is repeated until all the point sets are transferred from the processor 400 to the current controller 500. Then the process is returned to transfer the first point set.

The synchronous unit 300 can be used to control the time period for transferring the point sets from the processor 400 to the current controller 500.

The present invention can be applied to various rotatable objects. In the following, a wheel rotating with a high speed and a predetermined pattern are used for description.

As the wheel rotates with a high speed, the printed circuit boards will rotate with the wheel. Due to the effect of photogene, when the wheel rotates through an angle, the LEDs will light up according to different point sets transferred from the processor 400 to the current controller 500 so as to present a continuous pattern.

In the following, we will explain the principle about this phenomenon by an example. For example a car drives with a speed of 60 kilometer per hour with wheels having a diameter of 33 centimeters. The pattern in the third printed circuit board is desired to cover an angle range of 120 degrees. Thus, the speed can be converted into meters per second by the operation that 60 (km/hr)×1000 (m/km)×1/3600(hr/s)=16.6666 (m/s). A periphery of the wheel is 2πR=2×3.14×0.33 m=2.07 m. Thus the wheel rotates through 16.6666÷2.07=8 circle per second. That is, the wheel needs 0.125 second for rotating through one circle. If the pattern occupies 120 degrees (1/3 circle), the time showing the pattern as the wheel rotates through one circle is 0.0417 second. However in this short time period, human eyes will feel that the area sweeping through by the light emitting diodes is a continuous pattern as the pattern 30 on the third printed circuit board 3.

Furthermore, as we known the response time for the light emitting diodes to light up as a current to flow thereto is about 80 nanoseconds (ns), which is very short as comparing with the 0.0417 second per circle. Thus it can assure that the displayed pattern on the wheel has a sufficient resolution to make people view the pattern clearly.

For the speed of 60 km/h, it is 60 (km/hr)×1000000 (mm/km)×1/3600(hr/s)=1666.6666 (mm/s). Thus the displacement is 1666.6666 (m/s)×80×10-9S=0.0013333 mm. It supports that the light emitting diodes can respond the contact result real time.

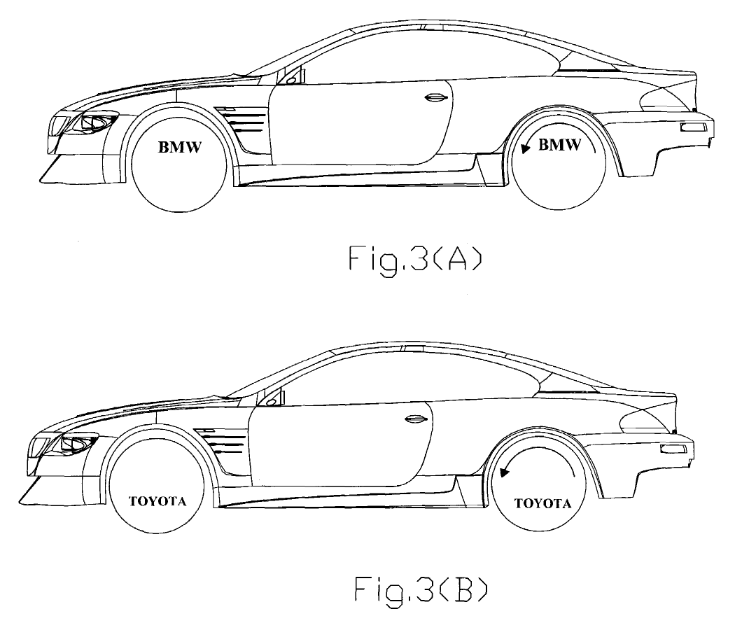

As illustrated in FIG. 3, the preferred embodiment of the present invention is that the present invention is used to tires of vehicles for advertisement, for example to display the LOGO of the manufacturers of the vehicles, such as BMW, BENZ, TOYOTA, etc.

In the present invention, the first printed circuit board 1 on the rotatable object rotates with the rotatable object. The light emitting diodes may be arranged as a bank, a half bank, a plurality of banks.

In the present invention, each light emitting diode may be formed by a plurality of LED sets. Each LED set includes a plurality of LED of different colors. Such as each LED set includes three LEDs, which a red LED, a green LED and a blue LED so as to present various colors as desired by corresponding wiring methods. Generally, the lifetime of an LED may be over 100,000 hours which is sufficient for use.

The present invention can be used to other rotating object, such as windmills, motorcycles, fans, rotatable advertisement boards, propellers of planes or helicopters; etc.

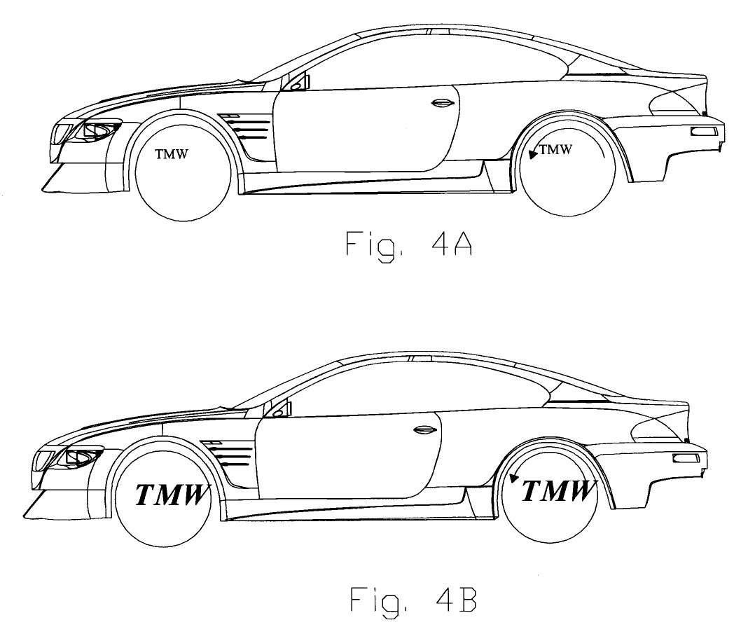

With reference to FIGS. 4A and 4B, it is illustrated that by controlling the time period for transferring the point sets from the processor 400 to the current controller 500. The width of the displaying pattern is controlled to be wider or narrower.

Advantages of the present invention are that a fixed pattern can be displayed on a rotating object. The pattern to be displayed is changeable and the width of the pattern is controlled. Thus it is a wide application in advertisement. Furthermore, the user can select any pattern he (or she) likes instead of only the pattern with advertisement objective.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An electronic LED display device for displaying a pattern on a rotatable object; wherein when the rotating object rotates with a high speed, the pattern will display; the device comprising:
a printed circuit board on the rotatable object is arranged with a bank of light emitting diodes;
a speed detection sensor for detecting speeds of the rotatable object;
a memory storing with at least one pattern and algorithms for displaying;
a processor being a controlling center; the processor receiving signals from the synchronous unit; wherein the processor processing a simulation calculation in which, a simulated projection line is projected to the pattern; the projection line is corresponding to the light emitting diodes; the projection line is formed by a plurality of points, each point represents a light emitting diode of the light emitting diodes in the printed circuit board; after projection, the points of an overlapping section of the projection line between the projection line and the pattern represents some of light emitting diodes corresponding to the point in the overlapping section will be lighted up; in the next time period, the projection line moves along a round path so as to drive the light emitting diodes to display with different pattern; and
a current controller receiving signals from the processor; the current controller controlling on-and-off operation of each of the light emitting diodes in the printed circuit board.

2. The electronic LED display device for displaying a pattern on a rotatable object as claimed in claim 1, further comprising:
an I/O (input/device) connected to the memory for inputting patterns to the memory;
a synchronous unit receives the speed signals from the speed detection sensor and determines a time period as a reference for lighting up the light emitting diodes; and the synchronous unit is used to control the time period for transferring the point sets from the processor to the current controller; and
a position sensor for detecting a position of the first printed circuit board on the rotatable object.

3. The electronic LED display device for displaying a pattern on a rotatable object as claimed in claim 1, wherein each light emitting diode is connected to the current controller through a conduction wire; the synchronous unit is connected to a power supply; all the conduction wires from the light emitting diodes are connected in parallel to the power supply through the switch bank; the current controller controls the on and off of each of the light emitting diodes through the switch bank.

4. The electronic LED display device for displaying a pattern on a rotatable object as claimed in claim 1, wherein the printed circuit board is arranged at one outer side of the rotatable object which can be easily viewed by viewers.

5. The electronic LED display device for displaying a pattern on a rotatable object as claimed in claim 1, wherein the pattern is at least one of texts and figures.

6. The electronic LED display device for displaying a pattern on a rotatable object as claimed in claim 1, wherein the pattern is a LOGO for vehicle manufacturers.

7. The electronic LED display device for displaying a pattern on a rotatable object as claimed in claim 1, wherein the light emitting diodes are arranged as a bank or a plurality of banks according to the rotation speed of the rotatable object.

8. The electronic LED display device for displaying a pattern on a rotatable object as claimed in claim 1, wherein the rotatable object is selected from windmills, vehicles, electric fans, propellers of planes and helicopters, and advertisement boards.
